(19) United States
(12) Patent Application Publication
(10) Pub. No.: US 2020/0156222 A1
(43) Pub. Date: May 21, 2020

(54) AIR IMPACT SCREW GUN SYSTEM AND METHOD

(71) Applicants: Emanuel Gingerich, Cuba, IL (US); Matthew Stambaugh, Cuba, IL (US)

(72) Inventors: Emanuel Gingerich, Cuba, IL (US); Matthew Stambaugh, Cuba, IL (US)

(21) Appl. No.: 16/664,850

(22) Filed: Oct. 26, 2019

Related U.S. Application Data
(60) Provisional application No. 62/770,066, filed on Nov. 20, 2018.

(51) Int. Cl. B25B 21/02; B25B 23/145

(52) U.S. Cl. CPC B25B 21/023; B25B 23/1453; B25B 21/026

(57) ABSTRACT

A light weight pneumatic screw gun. The screw gun may connect to an air compressor for installing metal roofing and wood screws in building structures. The screw gun may include a ¼″ drive and include means for up to 550 feet of torque. Further, the screw gun may provide a smoother impact with a double hammer and a different shape structure than conventional screw guns. The prior art devices appear to fail to singly provide your disclosed light weight pneumatic screw gun, ¼″ drive, 550 feet of torque, and double hammer in functional combination.

### CROSS-REFERENCE TO RELATED APPLICATION(S)

The present application is related to and claims priority to U.S. Provisional Patent Application No. 62/770,066 filed Nov. 20, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of tools of existing art and more specifically relates to a tool driving by impact delivering component or cooperating anvil.

### RELATED ART

Many people work on construction projects. When framing and roofing houses and barns or doing any other construction work, it can be time-consuming and laborious to manually drive screws into place. Many people end up needing frequent breaks or, even worse, hurting their hands, which causes an increase in downtime on jobsites and can potentially throw off an entire construction timeline. Instead, some workers may use a traditional screw gun, but they often lack efficiency and power. A suitable solution is desired.

U.S. Pub. No. 2010/0064,864 to Shigeki Kobayashi relates to a double hammer clutch impact tool. The described double hammer clutch impact tool is a power driven tool for rotating a mechanical fastener including a housing with a motor positioned in the housing. The motor includes a drive shaft that rotates relative to the housing. An impact mechanism in the housing is operatively connected to the motor drive shaft. The impact mechanism has a base, an output and a cam. The output and cam are rotatably mounted on the base. A pair of hammers are pivotally mounted on the base and selectively positioned by the cam. The cam biases the hammers to intermittently impact the output. A ratchet head assembly is operatively connected to the output of the impact mechanism. The ratchet head assembly includes an output member rotatably mounted on the housing to rotate the mechanical fastener. The assembly also includes a ratchet operable to limit rotation of the output member in a selected direction.

### SUMMARY OF THE INVENTION

In view of the foregoing disadvantages inherent in the known tool art, the present disclosure provides a novel air impact screw gun tool (system). The general purpose of the present disclosure, which will be described subsequently in greater detail, is to provide a reliable and efficient means to screw threaded fasteners.

The present invention uses an air compressor to drive screws into place for maximum impact, especially when framing and roofing houses and barns. The device alleviates some of the manual labor, reducing stress and strain on the body. It saves construction workers, contractors, and do-it-yourselfers a considerable amount of time and frustration. The device is lightweight and reduces the chance of injury, particularly to the hands. The device can provide up to 550 ft lbs of torque. The present invention helps keep workers on schedule, which helps keep clients happy which is desirable.

An air impact screw gun system is disclosed herein, the system comprising: an air impact screw gun having a housing; a driving means; an impactor; a hammer; a hammer pin; a hammer cage; and a control switch; wherein the driving means is substantially encased in the housing; the driving means configured to drive screw fasteners via a drive-shaft; the drive-shaft in communication with the driving means to transfer rotary motion and torque from the motor to drive the screw fasteners. The air impact screw gun provides up to 550 ft lbs of torque.

According to another embodiment, a method of use for the air impact screw gun system is disclosed herein, the method comprising the steps of: providing the air impact screw gun system; engaging screw fastener(s); and driving the screw fasteners using rotary and impact motion through at least one plane. The method may further comprise the step of alternately removing screw fasteners as desired.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an air impact screw gun system, constructed and operative according to the teachings of the present disclosure.

FIG. 1 is a perspective view of the air impact screw gun system, according to an embodiment of the disclosure.

FIG. 2 is a perspective view of the air impact screw gun system of FIG. 1, according to an embodiment of the present disclosure.

FIG. 3 is a perspective view of the air impact screw gun system during an ‘in-use’ condition of FIG. 1, according to an embodiment of the present disclosure.

FIG. 4 is an exploded view of the air impact screw gun system of FIG. 1, according to an embodiment of the present disclosure.

FIG. 5 is another exploded view of the air impact screw gun system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a tool and more particularly to an impact tool as used to improve the efficiency of screw drilling.

Generally speaking, the Air Impact Screw Gun offers a smooth impact and more power than a double hammer and traditional screw guns when driving screws into place. This novel product features a lightweight pneumatic screw gun that connects to an air compressor for installing metal roofing and wood screws in building structures. The screw gun can have a ¼″ drive, a protective aluminum housing, and the means for up to 550 feet of torque in preferred embodiments. Internal components can include springs, washers, sleeves, gaskets, bearings, pins, and a hammer clutch. In total, the screw gun measures approximately 6″ in length, 7″ in height, and 2.25″ in width. The following is a parts list for an embodiment of the present invention and the corresponding numbering for use in enablement below:

| Part | Description | Qty |
|---|---|---|
| 1 | Housing | 1 |
| 2 | Ball Bearing | 1 |
| 4 | Front Plate | 1 |
| 5 | D-Ring | 1 |
| 6 | Rotor | 1 |
| 7 | Blade | 6 |
| 8 | Spring | 6 |
| 9 | Cylinder | 1 |
| 10 | Spring Pin | 1 |
| 11 | Rear Plate | 1 |
| 12 | Ball Bearing | 1 |
| 13 | Packing | 1 |
| 14 | Packing | 1 |
| 15 | Cover | 1 |
| 16 | Screw (M5x 39.5) | 1 |
| 17 | Screw (M5x 62) | 4 |
| 18 | Trigger | 1 |
| 19 | Roll Pin | 1 |
| 20 | Retaining Ring | 1 |
| 21 | Regulator Dial | 1 |
| 22 | Steel Ball | 2 |
| 23 | Spring | 2 |
| 24 | Reverse Switch | 1 |
| 26 | Reverse Valve | 1 |
| 27 | Pin | 1 |
| 28 | O-Ring | 1 |
| 29 | O-Ring | 1 |
| 30 | Regulator Valve | 1 |
| 31 | Pin Valve Rod | 1 |
| 32 | Oil Seal | 1 |
| 33 | Pin Valve Rod | 1 |
| 34 | Cone Spring | 1 |
| 35 | Bushing | 1 |
| 36 | Sleeve | 1 |
| 37 | Oil Drop | 1 |
| 38 | Front Casing | 1 |
| 39 | Impact Bit Holder | 1 |
| 40 | Guard Sleeve | 1 |
| 41 | Spring | 1 |
| 42 | Flat Washer | 1 |
| 43 | Snap Washer | 1 |
| 44 | Hammer Pin | 2 |
| 45 | Hammer Cage | 1 |
| 46 | Hammer | 2 |
| 47 | O-Ring | 1 |
| 48 | Air Inlet | 1 |
| 49 | Exhaust Deflector | 1 |
| 50 | Screw (M3x 10) | 2 |
| 51 | Spring Pin | 2 |
| 52 | Bit 88 | 1 |
| 53 | Bit Retainer Sleeve | 1 |
| 54 | Spring | 1 |
| 55 | Bit Washer | 1 |
| 56 | Bit Ring | 1 |

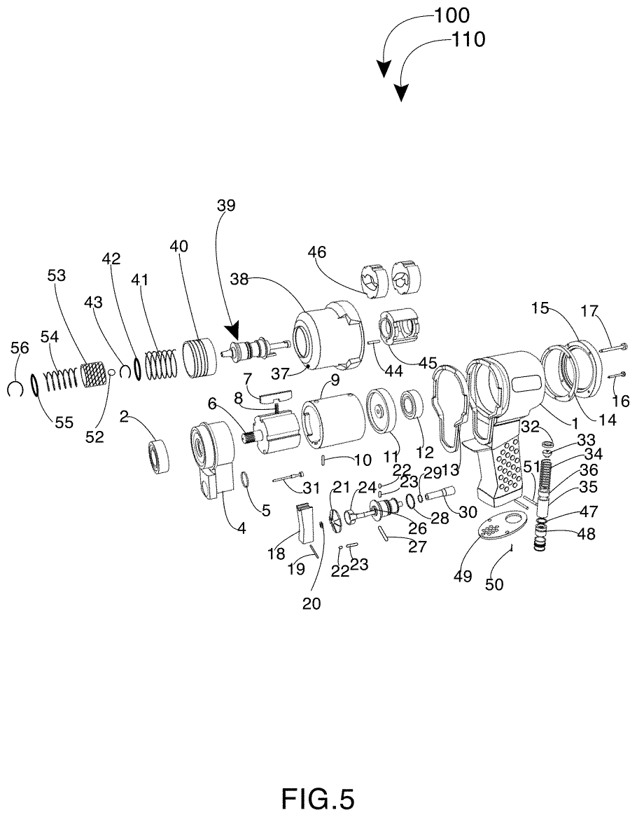

Certain embodiments may use the above-mentioned bit ring 56, bit washer 55, spring 54, bit retainer sleeve 53, at least one bit ball bearing 52, snap washer 43, flat washer 42, spring 41, guard sleeve 40, and impact bit holder 39 in combination as shown. Oil drop 37 is also shown. (FIG. 5).

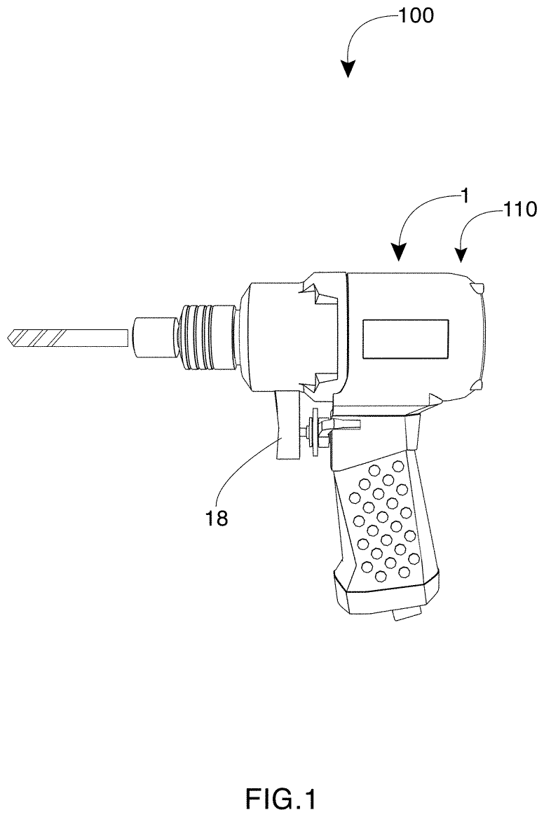

Referring now more specifically to the drawings by numerals of reference, there is shown in FIGS. 1-5, various views of an air impact screw gun system 100.

FIG. 1 shows the air impact screw gun system 100 during an ‘in-use’ condition 50, according to an embodiment of the present disclosure. Here, the air impact screw gun system 100 may be beneficial for use by a user to efficiently screw fasteners. As illustrated, the air impact screw gun system 100 may in a preferred embodiment include an air impact screw gun 110 having a housing 1; a motor (or means to drive the system 100 such as compressed air or the like); an impactor means including a hammer 46; a hammer pin 44; a hammer cage 45; ball bearings (2, 12); a blade 7; packings (13, 14); a trigger 18; roll pins 19; at least one retaining ring 20; a regulator dial 21; a reverse switch 24; a reverse valve 26; o-rings 5, 28, 29, 47); a regulator valve 30; at least one pin valve rod (31, 33); an oil seal 32; a cone spring 34; at least one bushing 35; a sleeve 36; a grease drop 37; a front casing 38; a bit ring; a bit-washer; a bit retaining sleeve; a spring; an air inlet 48; an exhaust deflector 49; and a spring pin 51.

The driving means (motor or other) is substantially encased in the housing 1. Those with ordinary skill in the art will now appreciate that upon reading this specification and by their understanding the art of driving means as described herein, methods of transitioning force through mechanical, pneumatic, electric, or other suitable means sufficient to drive fasteners will be understood by those knowledgeable in such art. The driving means is configured to drive screw fasteners via a drive-shaft or other suitable mechanical communication means in communication with the driving means to transfer rotary motion and torque from the driving means to drive the screw fasteners. The air impact screw gun 110 is lightweight and provides up to 550 ft lbs of torque for use in manipulating the screw fasteners. The present device also preferably comprises the other parts listed in the above chart and shown in the accompanying figures.

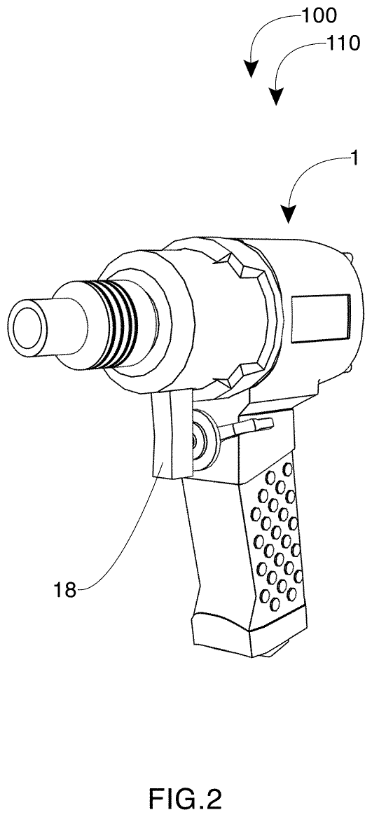

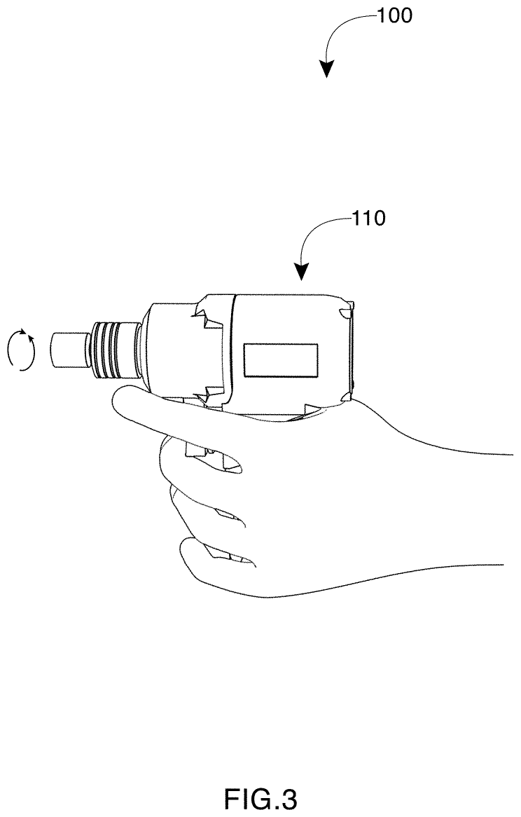

FIGS. 2-3 show perspective views of the air impact screw gun system 100. Instructions may detail functional relationships in relation to the structure of the air impact screw gun system 100 such that the air impact screw gun system 100 can be used, maintained, or the like, in a preferred manner.

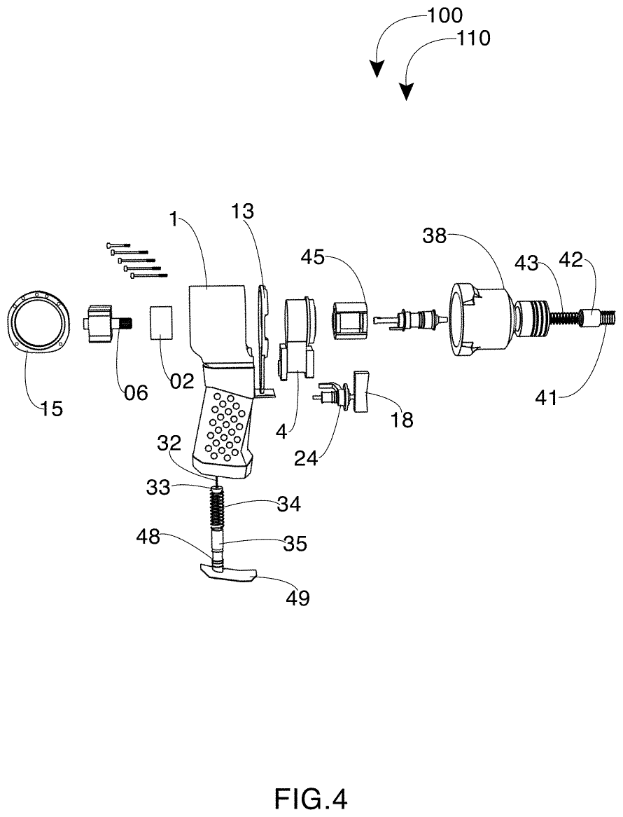

FIGS. 4-5 show exploded views of the air impact screw gun system 100 of FIG. 1, according to an embodiment of the present disclosure. Certain embodiments may use the above-mentioned bit ring 56, bit washer 55, spring 54, bit retainer sleeve 53, at least one bit ball bearing 52, snap washer 43, flat washer 42, spring 41, guard sleeve 40, and impact bit holder 39 in combination as shown. Oil drop 37 and retaining ring 20 is also shown. (FIG. 5).

A method for using the air impact screw gun system 100 may include one or more components or features of the air impact screw gun system 100 as described above. As illustrated, the method of use may include the steps of: step one, providing the air impact screw gun system 100; step two, engaging screw fastener(s); step three, driving the screw fasteners using rotary and impact motion through at least one plane. The device may alternately be used to remove screw fasteners as desired. It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use of the air impact screw gun system 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An air impact screw gun system, the system comprising:
an air impact screw gun having
a housing;
a driving means;
an impactor having;
a hammer;
a hammer pin;
a hammer cage; and
a control switch;
wherein said driving means is substantially encased in said housing, said driving means configured to drive screw fasteners via a drive-shaft, said drive-shaft in communication with said driving means to transfer rotary motion and torque from said driving means to drive said screw fasteners; and
wherein said air impact screw gun provides up to 550 ft lbs of torque.

2. The air impact screw gun system of claim 1, wherein said control switch is a trigger.

3. The air impact screw gun system of claim 2, further comprising a regulator dial.

4. The air impact screw gun system of claim 3, further comprising a bit retaining sleeve.

5. The air impact screw gun system of claim 4, further comprising at least one pin valve rod.

6. The air impact screw gun system of claim 5, further comprising a regulator valve.

7. The air impact screw gun system of claim 6, further comprising a reverse valve.

8. The air impact screw gun system of claim 7, further comprising a cone spring.

9. The air impact screw gun system of claim 8, further comprising a bit ring.

10. The air impact screw gun system of claim 9, further comprising a bit-washer.

11. The air impact screw gun system of claim 10, further comprising an air inlet.

12. The air impact screw gun system of claim 11, further comprising an exhaust deflector.

13. The air impact screw gun system of claim 12, wherein the hammer cage nests inside the front casing.

14. The air impact screw gun system of claim 13, wherein the hammer pin is inserted through the hammer cage.

15. The air impact screw gun system of claim 1, wherein the hammer pin is in communication with said hammer.

16. The air impact screw gun system of claim 1, wherein the hammer comprises a two-piece construction.

17. An air impact screw gun system, the system comprising:
an air impact screw gun having
a housing;
a driving means;
an impactor;
a hammer;
a hammer pin;
a hammer cage;
ball bearings;
a blade;
packings;
a trigger;
roll pins;
at least one retaining ring;
a regulator dial;
a reverse switch;
a reverse valve;
o-rings;
a regulator valve;
at least one pin valve rod;
an oil seal;
a cone spring;
at least one bushing;
a sleeve;
a grease drop;
a front casing;
a bit ring;
a bit-washer;
a bit retaining sleeve;
a spring;
an air inlet;
an exhaust deflector; and
a spring pin; and
wherein said driving means is substantially encased in said housing, said driving means configured to drive screw fasteners via a drive-shaft, said drive-shaft in communication with said driving means to transfer rotary motion and torque from said driving means to drive said screw fasteners; and
wherein said air impact screw gun is lightweight and provides up to 550 ft lbs of torque for use in manipulating said screw fasteners.

18. The air impact screw gun system of claim 17, further comprising a set of instructions.

19. A method of use for an air impact screw gun system, the method comprising the steps of:
providing the air impact screw gun system;
engaging screw fastener(s); and
driving the screw fasteners using rotary and impact motion of up to 550 ft lbs torque through at least one plane.

20. The method of claim 19, further comprising the step of alternately removing screw fasteners as desired.
